(19) United States
(12) Patent Application Publication
(10) Pub. No.: US 2008/0312566 A1
(43) Pub. Date: Dec. 18, 2008

(54) Tapping mechanism for use in a massage device of a massage machine

(76) Inventor: Ko-Po Chen, Ta-Li City (TW)

Correspondence Address: PRO-TECHTOR INTERNATIONAL SERVICES, 20775 NORADA CT., SARATOGA, CA, 95070, US

(21) Appl. No.: 11/818,377

(22) Filed: Jun. 14, 2007

(51) Int. Cl. A61H 7/00

(52) U.S. Cl. 601/84

(57) ABSTRACT

A tapping mechanism for use in a massage device of a massage machine comprises first and second swing arms including first and second massage rollers, respectively, and a tapping mechanism applied to actuate the first and second massage rollers to have a tapping massage, wherein the tapping mechanism is utilize a driver to urge a tapping shaft, and the tapping shaft includes a transmitting member axially disposed at one end thereof for a lateral displacement, and the transmitting member includes a swing element axially provided at another end thereof for frontward and rearward swing and having first and second rod members pivotally coupled at two ends thereof, and the first and second rod members includes first and second swing arms axially coupled thereon, respectively, such that the first and second massage rollers may alternately tap user's back at the same lateral height.

### BACKGROUND OF THE INVENTION

1. Field of the Invention

The present invention relates to a tapping mechanism for use in a massage device of a massage machine, first and second rod members of which may actuate first and second massage rollers to alternately tap or knead user's back at the same height for enhancing the massaging comfortness.

2. Description of the Prior Arts

Referring to FIGS. 1-3, TW Pat. No. 92211833 to Chen discloses “Massaging Device of Massaging Machine” including a kneading mechanism 1 and a tapping mechanism 2, wherein the kneading mechanism 1 includes a motor 11 for a driver, by which a pulley assembly 12 is urged and may actuate a kneading shaft 13 to rotate, the kneading shaft 13 includes first and second swing arms 14 and 15 having first and second massage rollers 16 and 17 individually affixed at two ends thereof, and the tapping mechanism 2 includes a motor 21 for a driver, by which a pulley assembly 22 is driven and may actuate the rotation of a tapping shaft 23. The tapping shaft 23 includes first and second eccentric segments 231 and 232 mounted at two ends thereof and having first and second holders 24 and 25 axially attached thereon, the first and second holders 24 and 25 contains first and second rod members 26 and 27 pivotally coupled onto the first and second swing arms 14 and 15. During the kneading massage, the motor 11 drives the pulley assembly 12 to actuate the rotation of the kneading shaft 13, and the kneading shaft 13 may apply the eccentric segments at two ends thereof to actuate the first and second swing arms 14, 15 and the first and second massage rollers 16, 17 for having an alternate change so that the first and second massage rollers 16 and 17 may have a kneading operation, and by way of the motor 21, the pulley assembly 22 is urged to actuate the rotation of the tapping shaft 23, hence the tapping shaft 23 may employ the first and second eccentric segments 231, 232 to actuate the upward and downward displacement of the first and second rod members 26 and 27, and the first and second rod members 26 and 27 actuate the first and second swing arms 14, 15 and the first and second massage rollers 16, 17 to cause an upward and downward swing, thus alternatively tapping user's back.

However, because the first and second swing arms 14 and 15 are both coupled to the kneading shaft 13 of the kneading mechanism 1 and the first and second rod members 26, 27 of the tapping mechanism 2, the kneading mechanism 1 and the tapping mechanism 2 may cause an influence relative to the first and second massage rollers 26 and 27. As shown in FIG. 3, the first and second eccentric segments 231 and 232 are eccentrically designed and face upward or downward, thus obtaining an eccentrically distance difference. If using the first and second rod members 26A and 27A with different lengths to compensate the eccentrically distance differences and axially couple the first and second swing arms 14 and 15, the first and second massage rollers 16 and 17 may maintain at the same lateral height so as to have a kneading massage, yet during the tapping massage, the first and second massage rollers 16 and 17 may tap user's back at the different lateral height and form a height distance difference, causing a tapping uncomfortness.

In contrast, referring to FIG. 4, during the tapping operation, the first and second massage rollers 16 and 17 alternately tap user's back at the same lateral height, while during the kneading operation, the first and second massage rollers 16 and 17 may result in an eccentric distance difference, such as a height distance difference B, therefore the first and second massage rollers 16 and 17 may have a kneading massage at different heights, causing a massage uncomfortness.

The present invention has arisen to mitigate and/or obviate the afore-described disadvantages.

### SUMMARY OF THE INVENTION

The primary object of the present invention is to provide a tapping mechanism for use in a massage device of a massage machine that the first and second massage rollers alternately tap user's back at the same lateral height, thereby obtaining an evenly massaging comfortness.

Another object of the present invention is to provide a tapping mechanism for use in a massage device of a massage machine that the first and second massage rollers knead user's back at the same lateral height so as to achieve a kneading comfortness.

In accordance with one aspect of the present invention, there is provided a tapping mechanism for use in a massage device of a massage machine comprising first and second swing arms including first and second massage rollers, respectively, and a tapping mechanism applied to actuate the first and second massage rollers to have a tapping massage, wherein

the tapping mechanism is utilize a driver to urge a tapping shaft, and the tapping shaft includes a transmitting member axially disposed at one end thereof for a lateral displacement, and the transmitting member includes a swing element axially provided at another end thereof for a frontward and rearward swing and having first and second rod members pivotally coupled at two ends thereof, and the first and second rod members includes first and second swing arms axially coupled thereon, respectively, such that the first and second massage rollers may alternately tap user's back at the same lateral height.

Since the lengths of the first and second rod members are the same as each other and axially connected at the same lateral position of the swing element, during the kneading massage operation, the kneading shaft actuates the first and second swing arms and the first and second massage rollers to move, thus the first and second massage rollers knead user's back at the same lateral height so as to achieve a kneading comfortness.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram illustrating a tapping mechanism of TW Patent No. 92211833;

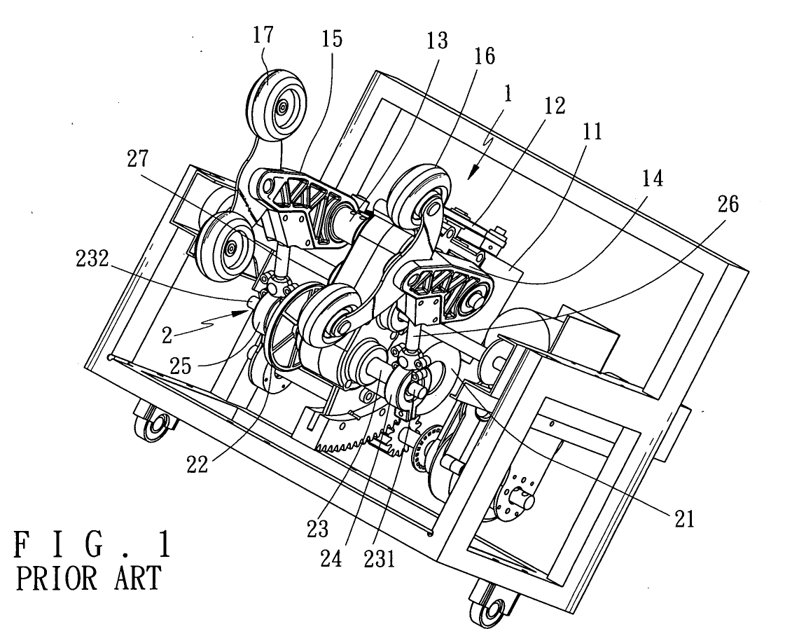

FIG. 2 is a partial perspective diagram illustrating the tapping mechanism of TW Patent No. 92211833;

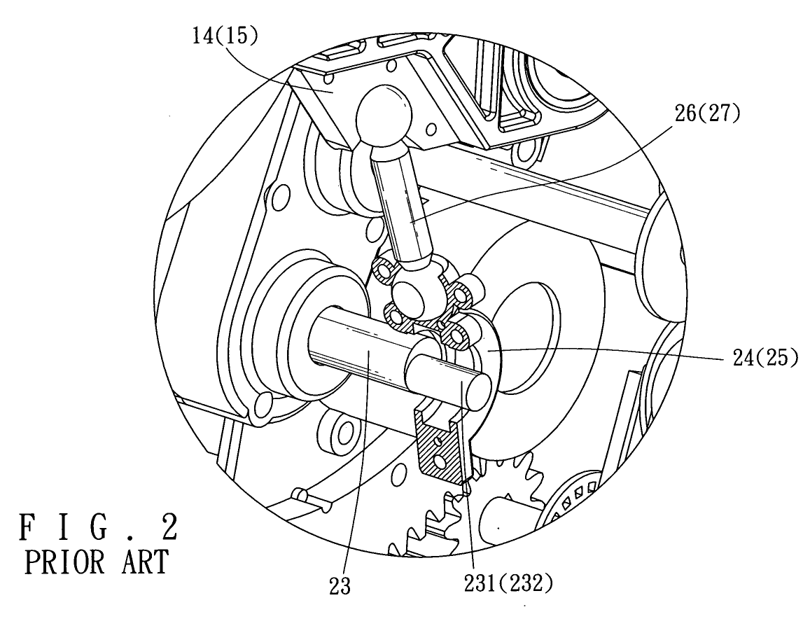

FIG. 3 is a front plane diagram illustrating the tapping massage operation of prior art first and second massage rollers;

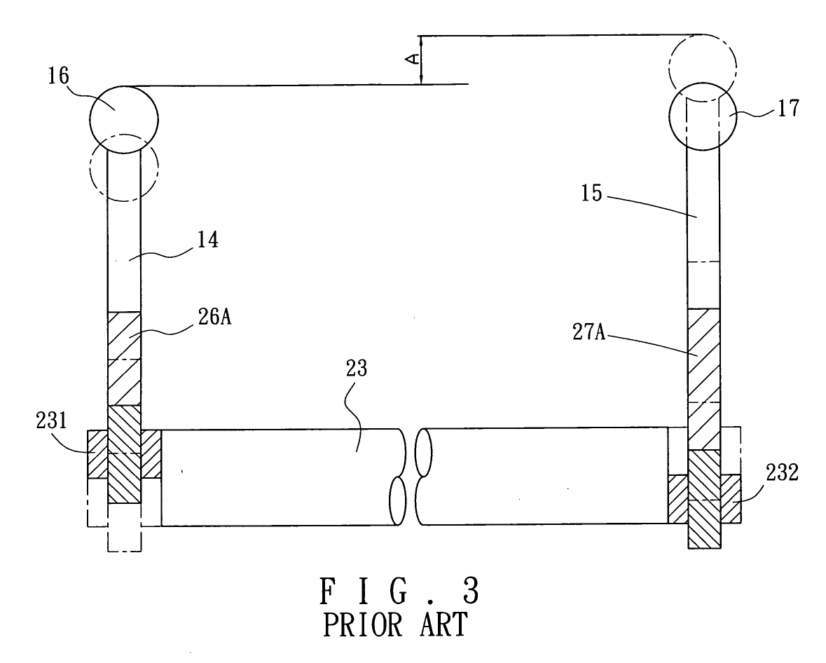

FIG. 4 is a front plane diagram illustrating the kneading massage operation of prior art first and second massage rollers;

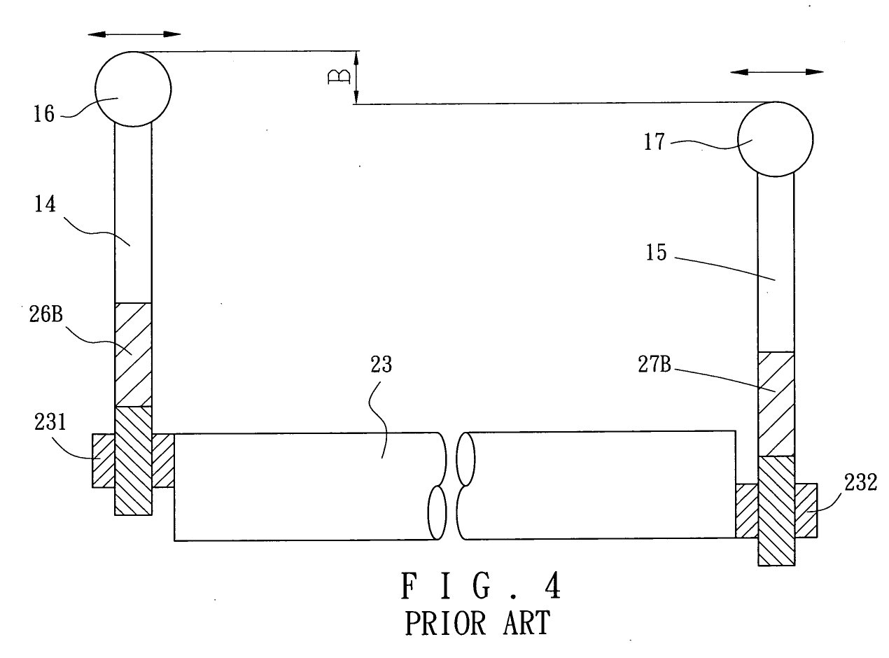

FIG. 5 is a perspective diagram of a tapping mechanism of the present invention;

FIG. 6 is another perspective diagram of the tapping mechanism of the present invention;

FIG. 7 is a top plane diagram of the tapping mechanism of the present invention;

FIG. 8 is a front plane diagram of the tapping mechanism of the present invention;

FIG. 9 is a plane diagram illustrating the tapping operation status of a first massage roller of the present invention;

FIG. 10 is a front plane diagram according to FIG. 9;

FIG. 11 is a plane diagram illustrating the tapping operation status of a second massage roller of the present invention;

FIG. 12 is a front plane diagram according to FIG. 11;

FIG. 13 is a plane diagram illustrating the kneading operation status of first and second massage rollers of the present invention;

FIG. 14 is a front plane diagram according to FIG. 13.

### DETAILED DESCRIPTION OF THE PREFERRED EMBODIMENT

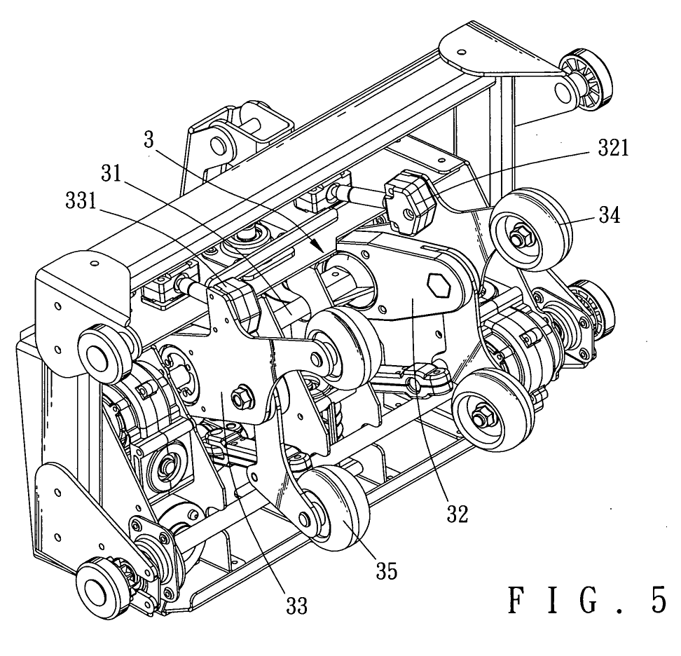

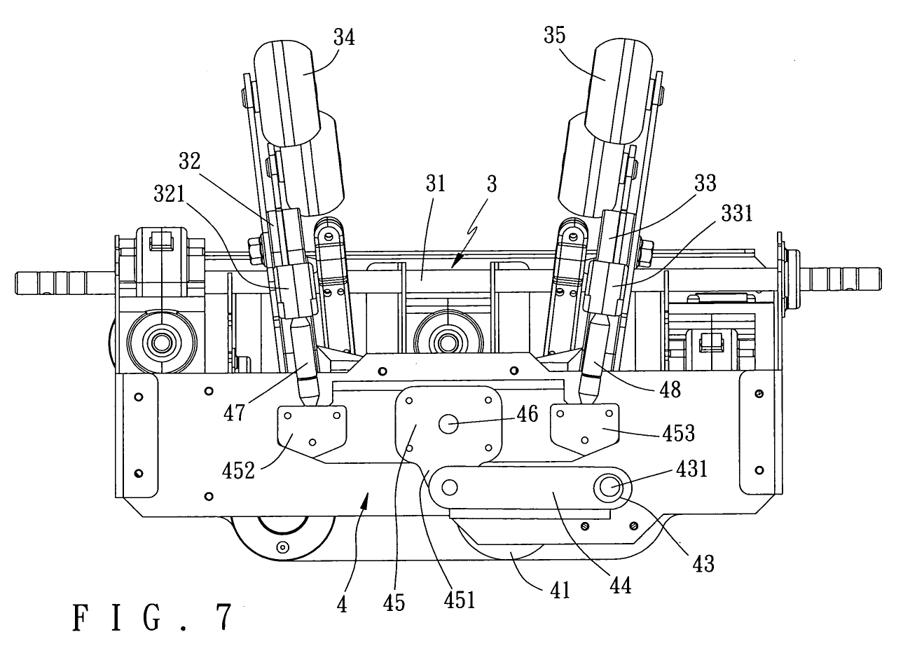

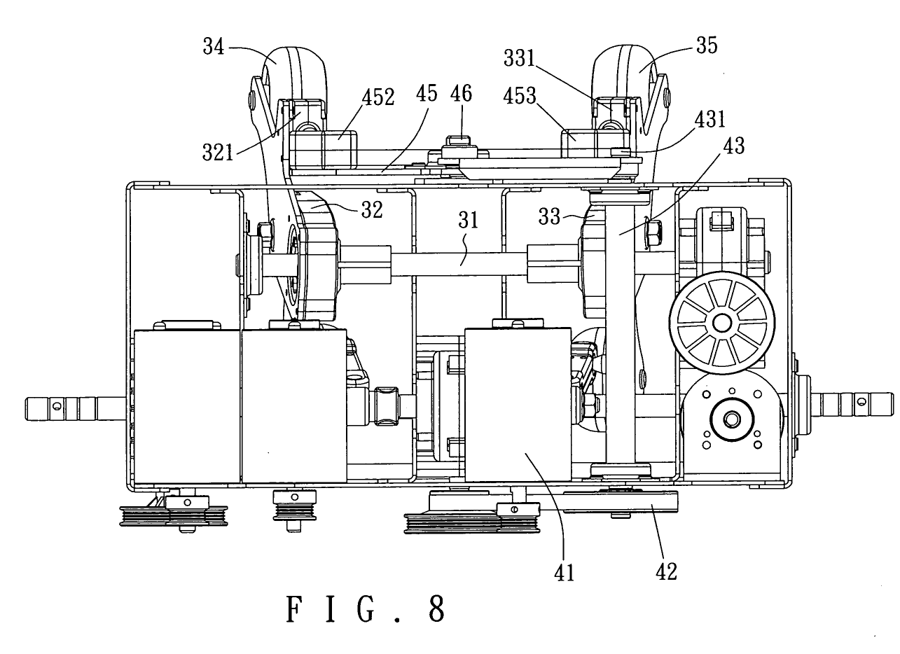

Referring to FIGS. 5-8, a tapping mechanism for use in a massage device of a massage machine in accordance with the present invention comprises a kneading mechanism 3 and a tapping mechanism 4 for kneading and tapping massages, wherein the kneading mechanism 3 includes a kneading shaft 31 disposed in the interior of a frame and having first and second swing arms 32 and 33 axially mounted at two ends thereof, the first and second swing arms 32, 33 includes first and second massage rollers 34 and 35, respectively, and the tapping mechanism 4 included a motor 4 provided at the interior of the frame, by which a pulley set 42 is driven to actuate the rotation of the tapping shaft 43, and the top end of the tapping shaft 43 extends out of the top surface of the frame and has an eccentric segment 431 attached thereon for axially coupling with a transmitting member 44. The transmitting member 44 includes a swing element 45 pivotally connected onto another end thereof and laterally placed on the top surface of the frame, and axially attached onto an offset stem 46 for horizontally front and rear movement, and includes an arresting portion 451 extendedly affixed at the rear surface thereof for pivotally coupling with the transmitting member 44. Since the swing member 45 is horizontally placed and may be provided a first lateral mount 452 and a second lateral mount 453 at two ends thereof and the same lateral height, by which first and second rod members 47, 48 with the same length are pivotally connected respectively, and the first and second rod members 47 and 48 further contains first and second longitudinal holders 321 and 331 individually provided at another ends thereof and axially mounted at the sides of the first and second swing arms 32 and 33, and because the lengths of the first and second rod members 47, 48 are equal and they are both axially secured at the same lateral position, maintaining the first and second massage rollers 34 and 35 at the horizontal positions of the upper, lower, front and rear sides thereof.

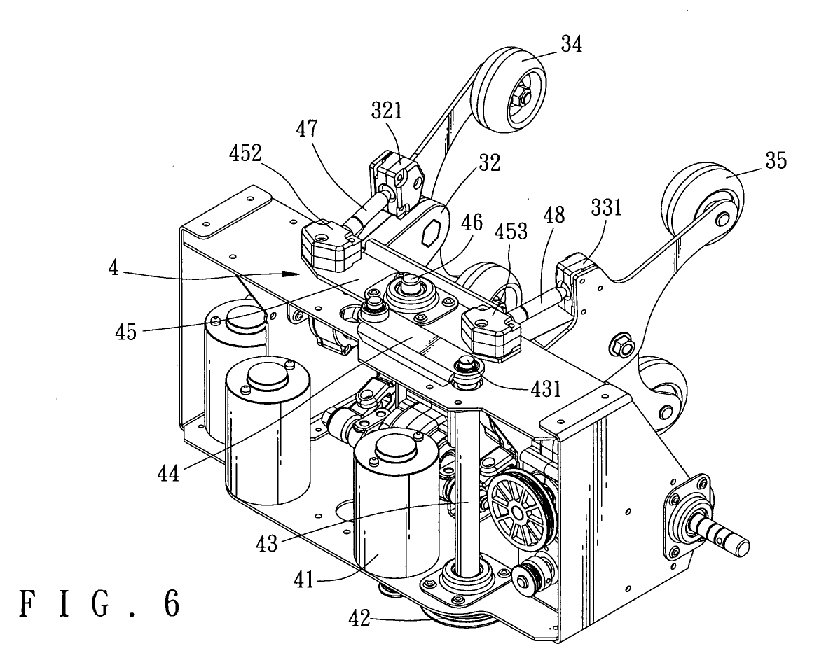

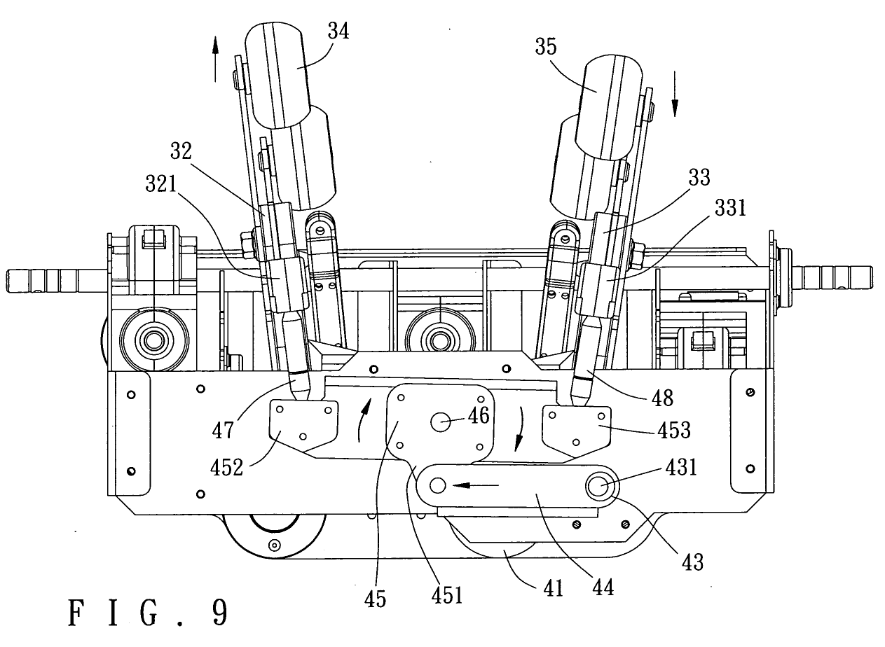

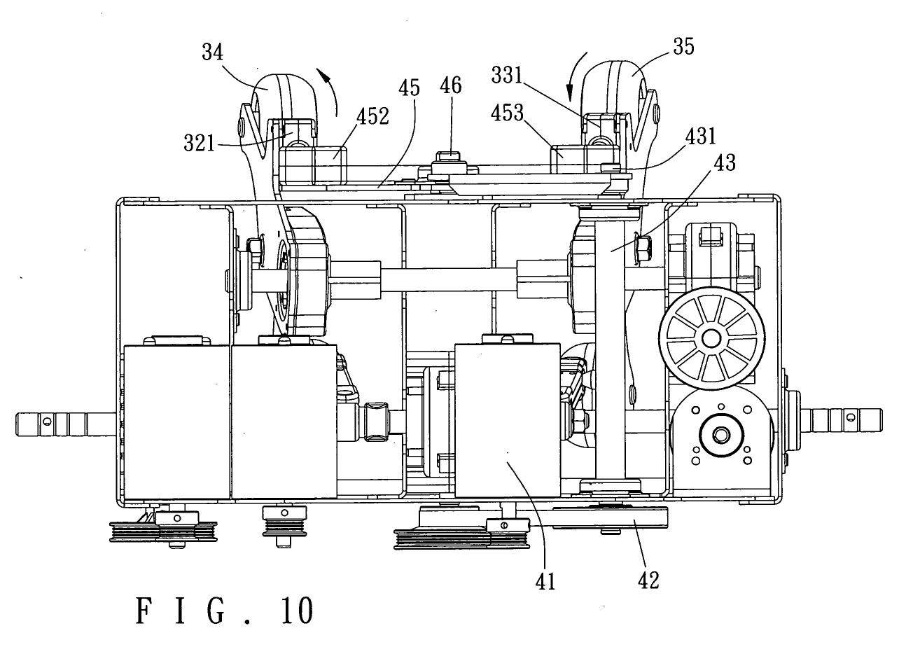

As shown in FIGS. 6, 9 and 10, while in use, the motor 41 may drive the pulley set 42 to actuate the rotation of the tapping shaft 43, the tapping shaft 43 may utilize the eccentric segment 431 to actuate the transmitting member 44 for eccentrically lateral displacement, and for using the eccentric segment 431 as the fulcrum to cause a properly angular swing. When the eccentric segment 431 actuates the transmitting member 44 to move horizontally, the swing element 45 may rotate along the offset stem 46, hence the first and second lateral mounts 452 and 453 may laterally swing, such that the first lateral mount 452 urges the first rod member 47 to move forward, and the first rod member 47 urges the first longitudinal holder 321 to actuate the first swing arm 32 and urge the first massage roller 34 to swing forward, accordingly the first massage roller 34 may tap user's back, and the second lateral mount 453 may also actuate the second rod member 48 to displace rearward so that the second rod member 48 drives the second longitudinal holder 331 to displace rearward for urging the second swing arm 33 and the second massage roller 35 to swing rearward.

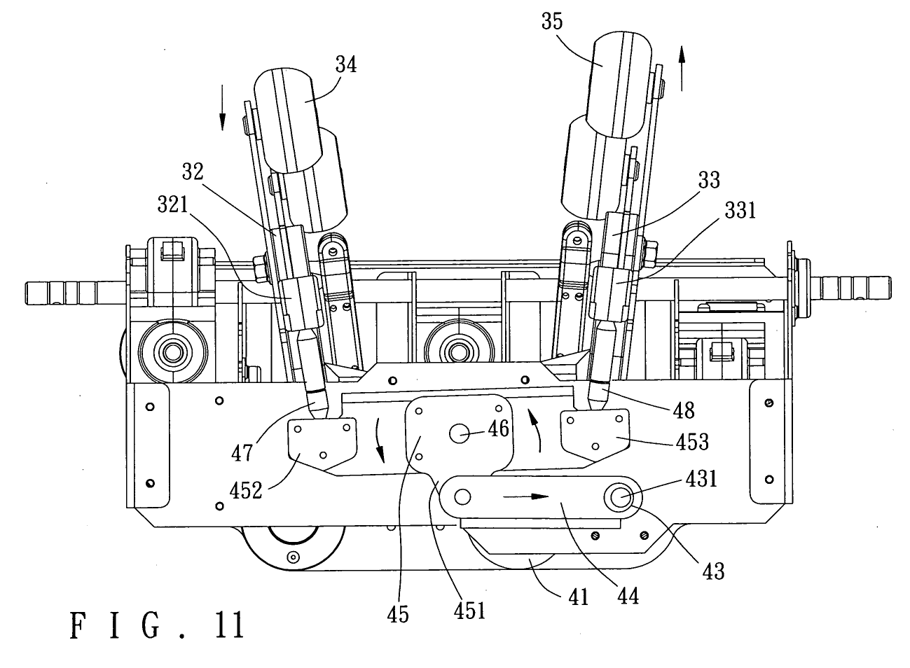

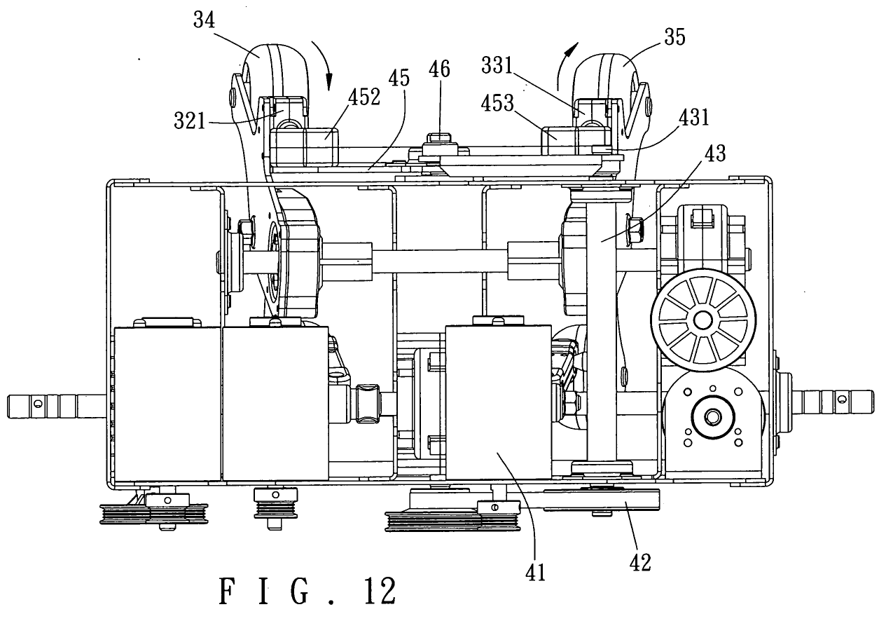

With reference to FIGS. 11 and 12, on the contrary, as the eccentric segment 431 actuates the transmitting member 44 to cause a rightward lateral displacement, the transmitting member 44 urges the arresting portion 451 to swing rightward, such that the swing element 45 may rotate along the offset stem 46 to urge the first and second lateral mounts 452 and 453 to cause a frontward and rearward lateral swing, and the second lateral mount 453 actuates the second rod member 48 to displace frontward so that the second rod member 48 urges the second longitudinal holder 331 to actuate the second swing arm 33 and the second massage roller 35 to swing frontward, such that the second massage roller 35 alternately taps user's back. Because the first and second massage rollers 34 and 35 are at the same lateral position for an alternately tapping massage, the tapping position of the second massage roller 35 is identical to the lateral height of the tapping position of the first massage roller 34, and the first lateral mount 452 also actuates the first rod member 47 to displace rearward, hence the first rod member 47 urges the first longitudinal holder 321 to move rearward, and the first swing arm 32 and the first massage roller 34 may be actuated to swing rearward so that the first and second massage rollers 34 and 35 alternately tap user's back at the same lateral height, thereby obtaining an evenly massaging comfortness.

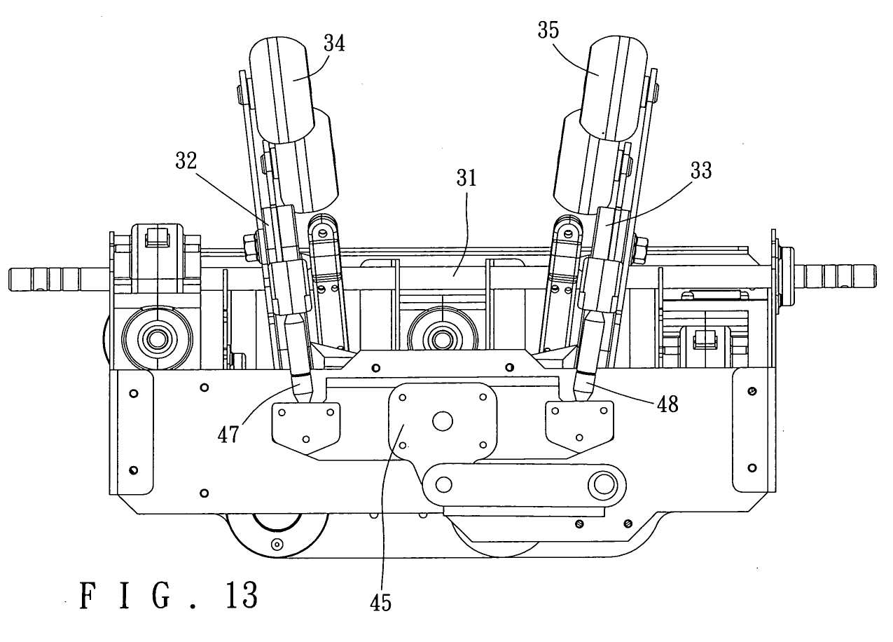

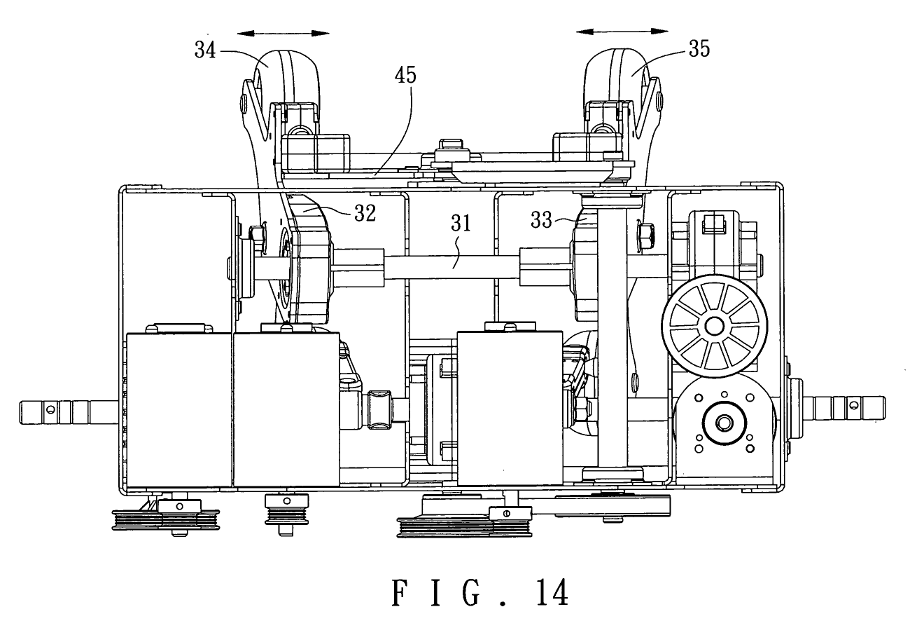

Referring to FIGS. 13-14, since the lengths of the first and second rod members 47 and 48 are the same as each other and axially connected at the same lateral position of the swing element 45, during the kneading massage operation, the kneading shaft 31 actuates the first and second swing arms 32, 33 and the first and second massage rollers 34, 35 to move, thus the first and second massage rollers 34 and 35 knead user's back at the same lateral height so as to achieve a kneading comfortness.

The invention is not limited to the above embodiment but various modifications thereof may be made. It will be understood by those skilled in the art that various changes in form and detail may made without departing from the scope and spirit of the present invention.

What is claimed is:

1. A tapping mechanism for use in a massage device of a massage machine comprising:
first and second swing arms including first and second massage rollers, respectively, and a tapping mechanism applied to actuate said first and second massage rollers to have a tapping massage, wherein
said tapping mechanism is utilize a driver to urge a tapping shaft, and said tapping shaft includes a transmitting member axially disposed at one end thereof for a lateral displacement, and said transmitting member includes a swing element axially provided at another end thereof for frontward and rearward swing and having first and second rod members pivotally coupled at two ends thereof, and said first and second rod members includes said first and second swing arms axially coupled thereon, respectively, such that said first and second massage rollers may alternately tap user's back at the same lateral height.

2. The tapping mechanism for use in a massage device of a massage machine in claim 1, wherein said driver of said tapping mechanism may be a motor.

3. The tapping mechanism for use in a massage device of a massage machine as claimed in claim 2, wherein said motor of said tapping mechanism is used to drive a pulley assembly, by which said tapping shaft is actuated to rotate.

4. The tapping mechanism for use in a massage device of a massage machine as claimed in claim 1, wherein said tapping shaft of said tapping mechanism is vertically disposed in the interior of a frame and includes an eccentric segment extending out of one end of the frame for connecting with said transmitting member.

5. The tapping mechanism for use in a massage device of a massage machine as claimed in claim 1, wherein said swing element of said tapping mechanism is axially attached at an offset stem of the frame, and includes an arresting portion extendedly affixed at the rear surface thereof for pivotally coupling with said transmitting member.

6. The tapping mechanism for use in a massage device of a massage machine as claimed in claim 1, wherein said swing member is horizontally placed and may be provided at two ends thereof and the same lateral height with a first lateral mount and a second lateral mount, by which said first and second rod members are pivotally connected respectively, and another ends of said first and second rod members are axially coupled at first and second longitudinal holders of said first and second swing arms.

7. The tapping mechanism for use in a massage device of a massage machine as claimed in claim 1, wherein said first and second rod members of said tapping mechanism have the same length.
